(19) United States
(12) Patent Application Publication
(10) Pub. No.: US 2003/0170602 A1
(43) Pub. Date: Sep. 11, 2003

(54) Interaction media device and experience transfer system using interaction media device

(76) Inventors: Norihiro Hagita, Seika-cho (JP); Kenji Mase, Seika-cho (JP); Makoto Tadenuma, Seika-cho (JP); Nobuji Tetsutani, Seika-cho (JP); Yasuhiro Katagiri, Seika-cho (JP)

Correspondence Address: Squire, Sanders & Dempsey L.L.P, 14th Floor, 801 S. Figueroa Street, Los Angeles, CA, 90017-5554, US

(21) Appl. No.: 10/360,384

(22) Filed: Feb. 6, 2003

(30) Foreign Application Priority Data
Feb. 7, 2002 (JP) 2002-30809(PAT.)

(51) Int. Cl. G09B 5/00

(52) U.S. Cl. 434/307 R

(57) ABSTRACT

The present invention provides an experience transfer system whereby human experience can be mutually shared. A cooperative media 1a acquires and stores the experience information of a first user by interacting with the first user autonomously and cooperatively, and a cooperative media 2b has a second user have the vicarious experience of the experience of the first user using the experience information of the first user read from the cooperative media 1a via the network 3.

### BACKGROUND OF THE INVENTION

1. Field of the Invention

The present invention relates to an interaction media device for interacting with humans autonomously and cooperatively, and an experience transfer system for mutually transferring human experience using the above device.

2. Description of the Related Art

Recently electronic mail and the Internet are spreading, where large volumes of information can be acquired, shared and transmitted on a global scale, and the globalization of politics, economy and culture has accelerated as well. As information infrastructures based on ultra high-speed networks become organized, an ubiquitous information distribution era, where anyone can exchange necessary information, anytime, anywhere, is close at hand.

When changes of media use is reviewed from the point of view of the spread of communication, the age of mass media, where information is transmitted from experts to the general public via text, sound and images, has started, which developed into the age of personal media, where individuals inter-transmit information, such as the case of using portable telephones and electronic mail, then moving into an age of community media in the 1990s, where individuals transmitted information to a community via groupware and the Web. Also in terms of the dimensions of media, media which a computer could handle expanded from text into sounds and images, and recently, media is expanding into one which includes a space called a “field”, represented by virtual reality (VR) and tele-existence.

The current Web, however, is a collection of documents based on hypertext, where a transmitter which transmits information unilaterally transfers document format knowledge information expressed by text and photos to receivers via the Internet, but this is not sufficient in order to transfer experiences, deep impressions, and the intentions of the transmitter to the receivers.

To implement ubiquitous information distribution, not only the globalization of information but also a view to mutually recognize the diversity of cultures and fields is necessary, but to implement communication beyond different cultures and different fields, a media which can be accessed on the Internet is insufficient at the moment.

Also to share experiences between a transmitter and receivers, merely translating the languages used by the transmitter and receiver is insufficient, for non-language information must be translated as well, and if the media which the transmitter and receivers use is different, then a translation involving media conversion unique to a non-language information, that is media translation, is required, but at the moment a technology which can execute such media translation has not been developed.

On the other hand, interaction media devices which perform interaction with humans are, for example, robots, wearable computers and agent systems, but these interaction media devices are based on standalone operation, and a technology which naturally guides users who behave freely in the real world to a specific purpose has not yet been established.

For example, in the case of an automatic response telephone number guide, a question is put to the user, the request of the user is extracted from the reply of the user, and the number is searched, but if the user gives a reply unrelated to the question, the system cannot advance to the next procedure. In the case of a role playing game in a video game, the creator of the game directs and creates a world where the behavior of the players are preset, and players play toward a goal, but this is an application of a video game limited in a special closed space on a computer, which is far from a target of supporting dally activities.

In Yasuyuki Kaku, Kenji Hazase: Agent solon: meeting and promotion of interaction using chat between personal agents, Journal of IEICE, Vol. J84-D-I, No. 8, pp. 1231-1243, August 2001. and Yasuyuki Kaku: Report on digital assistant project of JSAI 2000, Journal of Artificial Intelligence Society, Vol. 15. No. 6, pp. 1012- 1026, November 2000, a computer agent, which is attached to a user who acts in the real world and provides information according to the situation, has been implemented, and in the former paper, interaction between users is guided by interaction between agents, but in both papers, guiding users to a specific purpose while recognizing the situations of the user has not been implemented.

### SUMMARY OF THE INVENTION

It is an object of the present invention to provide an interaction media device and an experience transfer system using this device, which can mutually share human experiences.

(1) First Form of the Invention:

The interaction media device according to the first form of the present invention comprises acquisition means for acquiring experience information on human experience, storage means for storing the experience information acquired by the acquisition means, reproduction means for reproducing the experience, and control means for controlling the operation of the acquisition means, the storage means, and the reproduction means, wherein interaction with humans is performed autonomously and cooperatively by the control means, controlling the operation of the acquisition means, the storage means, and the reproduction means.

In the interaction media device according to the present invention, experience information about human experience is acquired while interaction is performed with humans autonomously and cooperatively, and the acquired experience information is stored, so the experience information can be observed at high accuracy by an easy operation. If this experience information is transmitted to another interaction media device, the experience can be reproduced in this information media device based on the experience information, so human experience can be mutually shared.

(2) Second Form of the Invention:

The interaction media device according to the second form of the present invention has the configuration of the interaction media device according to the first invention, wherein when an experience is reproduced, the reproduction means compares the experience information stored in the storage means and the experience information of the experience to be reproduced, and the experience information on the experience to be reproduced is converted into reproducible information.

In this case, the stored experience information and the experience information on the experience to be reproduced are compared, and the experience information on the experience to be reproduced is converted into reproducible information, so human experience can be mutually shared, even when media which the transmitter and receiver of the experience use are different.

(3) Third Form of the Invention

The interaction media device according to the third form of the present invention has the configuration of the interaction media device according to the first or second inventions, wherein the acquisition means, the storage means, the reproduction means, and the control means constitute a cooperative creation partner device for interacting with humans autonomously and cooperatively, the acquisition means, the storage means, the reproduction means, and the control means further comprises a plurality of acquisition means, a plurality of storage means, a plurality of reproduction means, and a plurality of control means respectively, the plurality of acquisition means, the plurality of storage means, the plurality of reproduction means and the plurality of control means constitute a plurality of cooperative creation partner devices, and the cooperative control means, for controlling the operation of the plurality of cooperative creation partner devices cooperatively, is further comprised so as to produce a predetermined effect and guide humans to a predetermined target.

In this case, a plurality of cooperative creation partner devices, which interact with humans autonomously and cooperatively, are comprised of the acquisition means, storage means, reproduction means and control means, and the operation of the plurality of cooperative creation partner devices is cooperatively controlled so as to produce a predetermined effect and guide humans to a predetermined target, so human action can be guided to a predetermined target adapting to the situations of humans.

(4) Fourth Form of the Invention

The experience transfer system according to the fourth form of the present invention is an experience transfer system for mutually transferring human experience, comprising a first and second interaction media devices which are connected to as to communicate mutually via a predetermined network, wherein the first interaction media device acquires and stores the experience information of a first user by interacting with the first user autonomously and cooperatively, and the second interaction media device has a second user have the vicarious experience of the experience of the first user using the experience information of the first user, which is read from the first interaction media device via the network.

In the experience transfer system according to the present invention, the first interaction media device acquires and stores the experience information of the first user by interacting with the first user autonomously and cooperatively, and the second interaction media device has the second user have the vicarious experience of the experience of the first user using the experience information of the first user, which is read from the first interaction media device via a network, so human experience can be mutually shared.

(5) Fifth Form of the Invention

The experience transfer system according to the fifth form of the present invention has the configuration of the experience transfer system according to the fourth invention, wherein the first user includes an expert, the second user includes a learner, the first interaction media device acquires and stores the technical skills of the expert by interacting with the expert autonomously and cooperatively, and the second interaction media device acquires and stores the personal information of the learner by interacting with the learner autonomously and cooperatively, and has the learner have the vicarious experience of the experience of the expert using the skills information of the expert read from the first interaction media device via a network and the stored personal information of the learner, so that the experience transfer is adapted to the learner.

In this case, the first interaction media device acquires and stores the skills information of an expert by interacting with the expert autonomously and cooperatively, and the second interaction media device acquires and stores the personal information of the learner by interacting with the learner autonomously and cooperatively, and has the learner have the vicarious experience of the experience of the expert using the skills information of the expert read from the first interaction media device via a network and the stored personal information of the learner, so that the experience transfer is adapted to the learner, therefore the learner can learn an advanced skills of the expert through experience without being forced to imitate the advanced skill of the expert from the beginning, or without ignoring the personality of the learner.

(6) Sixth Form of the Invention:

The experience transfer system according to the sixth form of the present invention has the configuration of the experience transfer system according to the fourth or fifth invention, wherein the first and second interaction media devices include the interaction media device according to one of the first to third inventions.

In this case, even when media which the transmitter and the receiver of the experience are using are different, human experience can be mutually shared, and human experience can be mutually shared while guiding the human action to a predetermined target, adapting to the situations of the humans.

### BRIEF DESCRIPTION OF THE DRAWINGS

FIG. 1 is a block diagram depicting a configuration of the experience transfer system according to an embodiment of the present invention;

FIG. 2 is a block diagram depicting a configuration of an example of the cooperative media shown in FIG. 1;

FIG. 3 is a block diagram depicting a configuration of an example of the five-sense media shown in FIG. 2;

FIG. 4 is a diagram depicting an example of the data content of the sub-interaction corpus when the steps of the brush work of calligraphy by a calligrapher is observed as experience information; and

FIG. 5 is a diagram depicting an example of experience shared communication for sharing an experience and creating a new experience.

### DESCRIPTION OF THE PREFERRED EMBODIMENTS

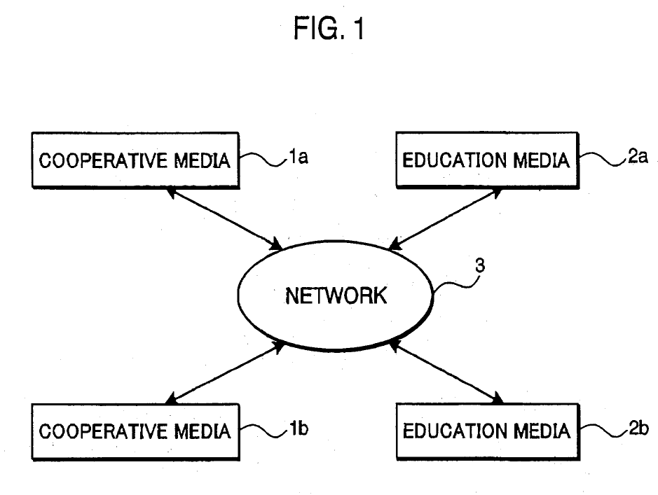

The experience transfer system according to the present invention will now be described with reference to the accompanying drawings. FIG. 1 is a block diagram depicting a configuration of the experience transfer system according to an embodiment of the present invention.

The experience transfer system shown in FIG. 1 is comprised of a cooperative media 1a and 1b, and education media 2a and 2b, where the cooperative media 1a and 1b and the education media 2a and 2b.are connected so as to communicate mutually via a network 3. In FIG. 1, two cooperative media, 1a and 1b, and two education media, 2a and 2b, are shown, but the number of cooperative media and education media to be connected via a network 3 is not limited to the above mentioned example, but one or three or more cooperative media or education media may be used

When the cooperative media 1a and 1b are used for transmitting experience, the cooperative media 1a and 1b observe the human experience, and recognizes and understands it by interacting with humans (interaction) autonomously and cooperatively, stores the experience information which was recognized and understood, and holds the stored experience information in a status that the experience information can be transmitted via the network 3. When the cooperative media 1a and 1b are used for reproducing experience, on the other hand, the cooperative media 1a and 1b download the experience information stored in the education media 2a and 2b or in another cooperative media, interprets the downloaded experience information, performs media conversion and media synthesis so as to match with the reproducing media of the education media 2a and 2b, and reproduces the experience.

When an expert, such as an artist or craftsman, uses the education media 2a and 2b, the education media 2a and 2b interact with the expert autonomously and cooperatively, so as to measure the experience information such as sensitivity information and skills in the creation process of an expert as skill information, to analyze the sensitivity information, etc. On the experience, in order to create a sensitivity and skills dictionary where the knowledge of the expert is stored from the analysis result, and to hold the stored skills information in a status where the information can be transmitted via the network 3. When the learner uses the education media 2a and 2b, on the other hand, the education media 2a and 2b interacts with the learner autonomously and cooperatively, so as to measure the personal information of the learner, to analyze the personal information, such as the sensitivity information, etc. on the experience, in order to create a personal dictionary of the learner, and to have the learner have the vicarious experience of the experience of the expert such that the experience transfer matches with the learner using the skills information of the expert, read from another education media via the network 3 and the stored personal information of the learner.

For the network 3, the Internet, for example, is used according to TCP/IP (Transmission Control Protocol/Internet Protocol), and data is transmitted/received mutually between the cooperative media 1a and 1b and the education media 2a and 2b. The network 3 is not especially limited to the Internet, but may be another network, such as an intranet, or a network combining various networks, such as the Internet and an intranet. The cooperative media 1a and 1b and the education media 2a and 2b may be inter-connected not via a network but via a leased line.

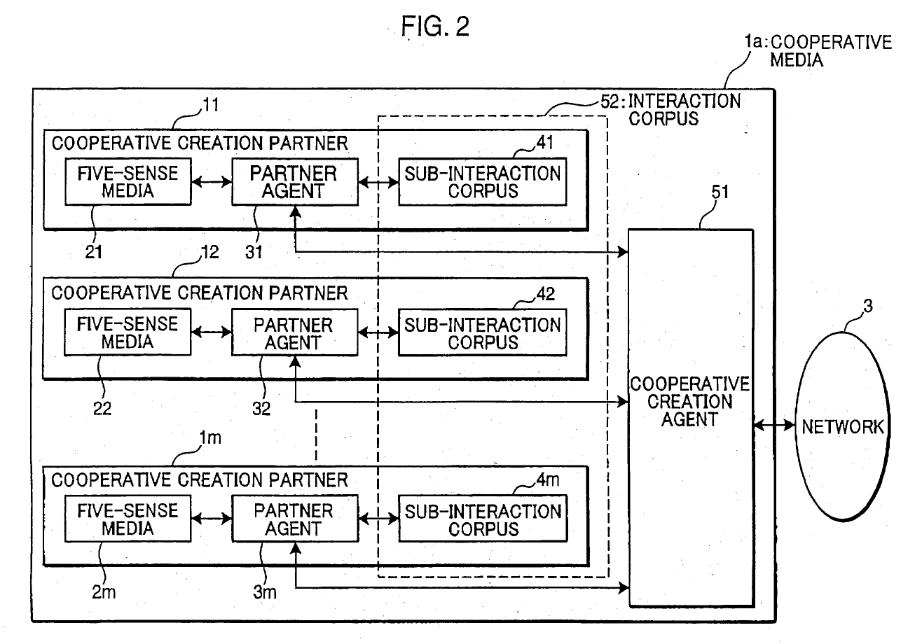

Now the cooperative media shown in FIG. 1 will be described in more detail. FIG. 2 is a block diagram depicting the configuration of an example of the cooperative media shown in FIG. 1. In the following descriptions, the cooperative media 1a is described as an example, but the cooperative media 1b and the education media 2a and 2b are also structured in the same way.

As FIG. 2 shows, the cooperative media 1a comprises m (m is an arbitrary positive number) number of cooperative creation partners 11-1m, and a cooperative agent 51, and each cooperative creation partner 11-1m further comprises five-sense media 21-2m, partner agents 31-3m, and sub-interaction corpuses 41-4m.

The cooperative creation partners 11-1m cooperates with humans by interacting autonomously, and creates new communication. For the cooperative creation partners 11-1m, a humanoid type robot, stuffed toy type robot, wearable computer, or a real world interface agent, for example, can be used, and these humanoid type robots and other cooperative creation partners can be the communication interface section of the computer whereby the subject is clear, and a human can interact clearly and easily.

When m=5, for example, the cooperative creation partner 11 is comprised of a robot, the cooperative creation partner 12 is a doll, the cooperative creation partner 13 is a structure embedded in a chair, desk or wall, the cooperative creation partner 14 is a wearable computer attached to the body of the user, and the cooperative creation partner 15 is comprised of a plurality of cameras and various physical sensation reproduction devices. These cooperative creation partners have interactive functions with the user, so as to interact with the user when necessary, depending on the experience observation result of the user or the experience reproduction result, and if the cooperative creation partner is a robot, doll or a structure, the cooperative creation partner also has a voice synthesis function, voice recognition function, and interaction control function.

The above mentioned cooperative creation partner is a generic term for an artificial object which major task is to create interaction with humans autonomously and cooperatively, and embraces a wide concept, including a communication robot and such an environment as clothes, a house and town, to execute the above functions, not only a personal agent which functions as a secretary and guide. For example, a robot, doll, clothes or furniture, in which sensors and an actuator are installed, speaks to the user as a cooperative creation partner, and observes the necessary experience information.

The cooperative creation partner can also be regarded as a media which expresses itself by interaction, and can express and process its own interactive experience information to share with someone else, or can implement a communication format to create a new experience.

A cooperative partner can also be used to solve the principle creation of interaction and behavior in human communication from a cognitive science perspective, and a computer interface with good operability can be established by making human behavior into models.

Each five-sense media 21-2m is comprised of a five-sense sensor for detecting the five human senses, visual, auditory, olfactory, gustatory and tactile, and an actuator to transfer these five senses to humans, and observes, recognizes and understands the five-sense information, biological information, and physical information of an experience, and reproduces the experience using the experience information.

Specifically, the five-sense media 21-2m measures, recognizes and understands the experiences, deep impressions and interactions of a user using pattern recognition and understanding technology and multi-media content retrieval technology, and acquires the experience information. For example, the five-sense media 21-2m measures and acquires human experience by observing human actions, body information, and heart rate, and reproduces the experience using tele-existence technology based on synchronized communication and virtual reality technology, including field expressions.

Each partner agent 31-3m is comprised of a CPU (Central Processing Unit) to control the operation of the cooperative creation partners 11-1m single unit, and is connected to the cooperative agent 51 via cable or radio to send the experience information to the cooperative agent 51, or to receive the information from the cooperative agent 51.

Each sub-interaction corpus 41-4m is comprised of such a storage device as a hard disk drive, and is installed inside the cooperative creation partners 11-1m respectively, stores the experience of the user and interaction measured by the five-sense media 21-2m in a data base in a format which the computer can process The data stored in the sub-interaction corpuses 41-4m is used as elementary data to reproduce experience or as a dictionary for the computer to recognize or understand the interaction and common sense of the user.

For example, the sub-interaction corpuses 41-4m not only create a knowledge base in the language area, such as in Cyc, Wordnet and EDR (electronic dictionary), but also systematically stores all the modality data which humans use, such as image, tactile, olfactory, gustatory and somatic senses in the non-language area, and includes the content where somatic tagging has been performed. For this tagging, the sub-interaction corpuses 41-4m not only continuously uses a conventional pattern recognition method, but also tags the data while creating interaction by the cooperative creation partners 11-1m, drawing the interaction into a certain domain. In this way, the sub-interaction corpuses 41-4m construct knowledge, called “implicit knowledge”, skills and daily interactions, as knowledge that a computer can recognize.

When the sub-interaction corpuses 41-4m are viewed from the cooperative agent 51, the sub-interaction corpuses 41-4m function logically as one integration corpus 52 by the control of the later mentioned cooperative agent 51.

The cooperative agent 51 is comprised of a CPU, and has multi-agent functions, and is also connected to each cooperative creation partner 11-1m in a status where data can be transmitted/received by cable or radio, and constructs the interaction corpus 52 based on the experience information of the user by controlling each cooperative creation partner 11-1m synchronously and asynchronously. The cooperative agent 51 has a gateway function, and is connected to the network 3 in a status where information can be transmitted or received.

When each cooperative creation partner 11-1m is comprised of a robot, wearable computer and agent system, the cooperative agent 51 recognizes the status of the user using image processing, voice processing, and sensor signal processing, operates the cooperative creation partners 11-1m interlocking with each other, and controls the cooperative creation partners cooperatively, so that experience information is accurately collected according to the effect producing rule embedded in advance according to the content of the experience.

For example, when the robot and the wearable computer interlock, the robot can initiate an action while observing the biological status of the user using the sensor information of the wearable computer, and can guide the experience. When a snap shot is taken, it is desirable that the eyes of the object look toward the camera, and the picture is taken showing a relaxed smile, so in this case, the humanoid type robot points a finger to guide the eyes of the object, that is the user, to the camera, and to give a clue, such as “smile now”, and the camera shutter can be pressed when the sensor of the wearable computer, which the user wears, detects biological information related to a smile. Also in order to observe the experience of the user accurately with limited sensors, the user can be guided to a location or arrangement which is appropriate for sensing by the gesture or interaction of the robot.

In the above description, the case when the cooperative media is comprised of a plurality of partner agents was described, but cooperative media may be comprised of one partner agent, and in this case, a cooperative agent is unnecessary.

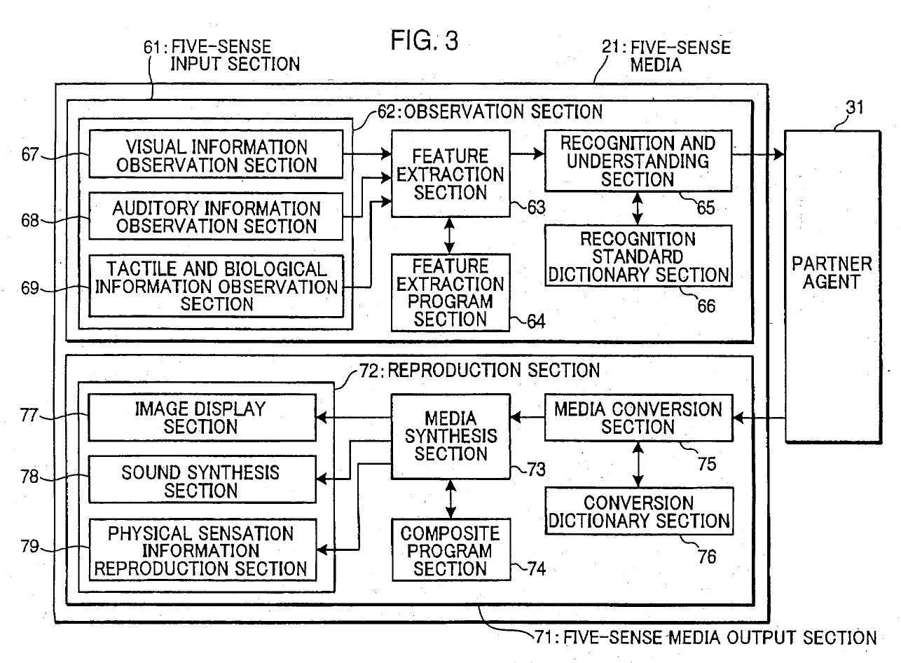

Now the five-sense media shown in FIG. 2 will be described in more detail. FIG. 3 is a block diagram depicting an example of the five-sense media shown in FIG. 2. In the following description, the five-sense medium 21 will be described as an example, but other five-sense media are comprised in the same way.

As FIG. 3 shows, the five-sense media 21 is comprised of a five-sense media input section 61 and a five-sense media output section 71. The five-sense media input section 61 is further comprised of an observation section 62, feature extraction section 63, feature extraction program section 64, recognition and understanding section 65, and recognition standard dictionary section 66, and the five-sense output section 71 is further comprised of the reproduction section 72, media synthesis section 73, composite (synthesizing) program section 74, media conversion section 75, and conversion dictionary section 76.

The five-sense media input section 61 observes the experience of the user, recognizes and understands the experience, and sends the result to the partner agent 31, and the experience information is stored in the sub-interaction corpus 41.

The observation section 62 is further comprised of one or more observation devices, and observes biological information, such as human actions, expressions, tactile senses, and pulse rate as an observation system which observes experiences, and collects each data using a method for following up human behavior from a plurality of cameras (see “Estimation of position and orientation of many cameras using movement of follow up target”, Information Processing Society of Japan, CVIM Workshop, 2002-CVIM-131-17, pp. 117-124, 2002), and on a method for following up the face and eyes (see “Detection and follow up of eyes for outputting eye position to eye camera”, Papers of Tech Group, IEICE, PRMU 2001-153, pp. 1-6, 2001), or a method of measuring pulse rate using a pulse rate sensor.

To perform the above mentioned processing, the observation section 62, for example, is comprised of a visual information observation section 67 which is further comprised of a plurality of cameras, an auditory information observation section 68 which is further comprised of a plurality of microphones, and a tactile and biological information observation section 69 which is further comprised of a plurality of bio-sensors. In the tactile and biological information observation section 69, an olfactory information observation section for observing olfactory information, and an gustatory information observation section for observing gustatory information, may be disposed.

The visual information observation section 67 observes the visual information of the user, the auditory information observation section 68 observes the auditory information of the user, the tactile and biological information observation section 69 observes the tactile and biological information of the user, and each observation data is input to the feature extraction section 63 as time series data. The tactile and biological information observation section 69 may observe ambient environment information, such as temperature, humidity, wind force and ion concentration. At this time, the feature extraction program of each observation system has been downloaded via the network 3 and stored in advance in the feature extraction program section 64. When a plurality of single-lens reflex cameras or omni-directional cameras are used for measurement, calibration information and information on the three-dimensional position of each camera are stored in the sub-interaction corpus 41 in advance. Also a recognition standard dictionary, including the class of the user's body to be recognized from the network 3 or interaction corpus 52 and the class of physical movement information, have been written from the recognition standard dictionary section 66 in advance to the recognition and understanding section 65. For example, for the class of the user's body, the left hand, right hand, shoulder, face, line of sight, direction of face, shape of mouth, brush, ink stone, paper, flute, guitar, frets of a flute, and strings of a guitar are included, and for the class of the physical movement information, holding a brush with the right hand, releasing a brush stroke, directing the brush to the ink stone, soaking the brush in ink, and the glissando playing method are included.

The feature extraction section 63 is comprised of a CPU, and by reading the feature extraction program of each observation system stored in the feature extraction program section 64, and by executing feature extraction processing, the feature extraction section 63 extracts the features and stores them in the feature parameter group, compares them with the feature parameters already stored, and outputs the feature data, such as feature vectors, to the recognition and understanding section 65.

The feature extraction section 63 also performs normalization processing for collating with the recognition standard dictionary section 66 at high precision-based on such physical information as height, physical build, heart rate, and perspiration information stored in the sub-interaction corpus 41. In this normalization processing, 150 cm physical height and 70 cm arm length are stored as physical information in the recognition standard dictionary section 66, and if the height of the user is 180 cm and the arm length is 80 cm, for example, then necessary processing is performed to normalize each parameter of the feature extraction program for determining the position of the arm to be 180 cm and 80 cm for measurement.

The recognition and understanding section 65 is comprised of a CPU, and performs various analyses based on the feature data, performs comparison calculation between the feature vectors which were input in the recognition processing, and the vectors stored in the recognition standard dictionary section 66 using known identification functions, and outputs the recognition class which presents the maximum degree of coincidence as the recognition result. For example, the recognition and understanding section 65 recognizes and understands whether the object is searching for an object or walking toward a target location from the feature data of the movement as a behavior pattern, or the recognition and understanding section 65 follows up the face and recognizes and understands psychological status from the inclination and degree of movement of the face, such as an uneasy, stable, depressed or manic status, or recognizes and understands an excited or normal status from the pulse rate. Also the recognition and understanding section 65 judges whether three-dimensional restoration is possible using the observation result which is output from a plurality of cameras for three-dimensional image measurement, and sends the judgment result to the partner agent 31.

Each one of the above mentioned processings is controlled by the partner agent 31, and the partner agent 31 stores the recognition result and the observation data in the sub-interaction corpus 41 as experience information, and for example, the above mentioned series of flow of time axes is sent to the sub-interaction corpus 41, and is stored.

The five-sense media output section 71 compares the content of the interaction corpus 52 on the experience information of the user and the content of the interaction corpus of another user which is received via the network 3, and performs media synthesis by converting the received experience information of another user so as to match with the reproduction section 72.

The reproduction section 72 reproduces sounds, images, tactile senses (e.g. touch, sense of inner force, relaxation stimulation, wind, temperature environment, humidity environment), smell, taste, etc. as the reproduction system for reproducing vicarious experiences. For example, the reproduction section 72 is comprised of an image display section 77 which is further comprised of a plurality of image display devices, a sound synthesis section 78 which is further comprised of a plurality of speakers, and a physical sensation information reproduction section 79 which is further comprised of a plurality of physical sensation devices. As one of the examples of physical sensation information reproduction section 79 includes a haptic device that generates a resistance force in a grip portion of the device in accordance with the movement of the device in a 3D space with respect to a virtual 3D model so that the operator can feel the feedback force on the grip as if he/she touched the real model. Other example thereof is shown in Unexamined Japanese Patent Publication No. P2000-181618A, published on Jun. 30, 2000; a device allows a user's hand to feel feedback forces in terms of rotations around three different axes (1^{st} to 3^{rd} axes) and a 4^{th} feedback force along another axis with the use of the respective actuators so that the user, who is remote from a place where another user is experiencing the tactical resistance forces in some physical activities, can sense the tactical feedback similar to the tactical resistance forces felt by another user.

The media conversion section 75 is comprised of a CPU, and compares the information of the interaction corpus 52 on the experience information of the user and information on the media environment and the physical information of another user, creates a conversion dictionary, and stores it in the conversion dictionary section 76. For example, in the case of the physical information normalization conversion processing, if the height of a user who transmitted experience information is 180 cm and their arm length is 80 cm, and the height of the user who received the experience information is 160 cm and their arm length is 70 cm, then each parameter of the media synthesis program for determining the position of the arm at reproduction is normalized to 160 cm and 70 cm, in order to determine the reproduction parameters. Also if the experience of a user is measured using three cameras and another user shares that experience using two cameras, then media conversion is performed so that the experience information measured using three cameras can be reproduced using two cameras.

The conversion dictionary section 76 stores the referenced information (or so called normalized information) regarding for instance sizes of the predetermined body parts (such as height and a arm length being 150 cm and 60 cm respectively) such that the referenced information functions as basis for normalization processing. For instance, an experience of a first user whose height is 200 cm walking comfortably along a golf course cannot be reproduced to a second user unless the second user is as tall as 200 cm. That is why the aforementioned normalization process is required based on the normalized information stored in the conversion dictionary section 76.

The media synthesis section 73 is comprised of a CPU, and reads the composite (synthesizing) program stored in the composite (synthesizing) program section 74, and executes the media synthesis processing, so that the feature data which is converted by the media conversion section 75 so as to match the reproduction section 72, is compared and synthesized with the feature parameter group, referring to the content of the conversion dictionary section 76, and is converted into signals which the production section 72 can access, and reproduces the experience using the reproduction section 72. The composite (synthesizing) program stored in the composite (synthesizing) program section 74 has been downloaded and stored in advance from the network 3 or from the interaction corpus of the cooperative media which transmitted the experience information.

After the above mentioned processing ends, one of the cooperative creation partners 11-1m notifies the user who uses the cooperative media 1a that the experience of another use can be reproduced, and the shared experience is reproduced for the user B. If the user complains or questions something about the shared experience from the user at this time, one of the cooperative creation partners 11-1m interacts with the user when necessary, and repeats reproduction with changing parameters by the media conversion section 75 and the media synthesis section 73 until the desired shared experience is implemented.

In this way, in the five-sense media 21 shown in FIG. 3, media conversion can be performed adding information conversion adapted to the user, that is an individual who will have a vicarious experience, using physical information (e.g. height, weight, gender, athletic capabilities, vision, age) stored in the interaction corpus of another cooperative media via the network 3, so an experience can be reproduced simultaneously for many users. Also, the observation section 62 and the reproduction section 72 are disposed separately so that the reproduction section 72 can provide a vicarious experience to the user while the observation section 62 is observing the user at the same time, therefore a feedback function for changing signals to be output to the reproduction section 72, based on the observation result of the observation section 62, can be implemented, and the vicarious experience can more closely approach the experience at observation.

In the present embodiment, the cooperative media 1a and 1b and the education media 2a and 2b correspond to the interaction media device and the first and second interaction media devices, the five-sense media 21-2m corresponds to the acquisition means and reproduction means, the five-sense media input section 61 corresponds to the acquisition means, the five-sense media output section 71 corresponds to the reproduction means, the sub-interaction corpuses 41-4m corresponds to the storage means, the partner agents 31-3m corresponds to the control means, the cooperative partners 11-1m corresponds to the cooperative creation partner device, and the cooperative agent 51 corresponds to the cooperative control means.

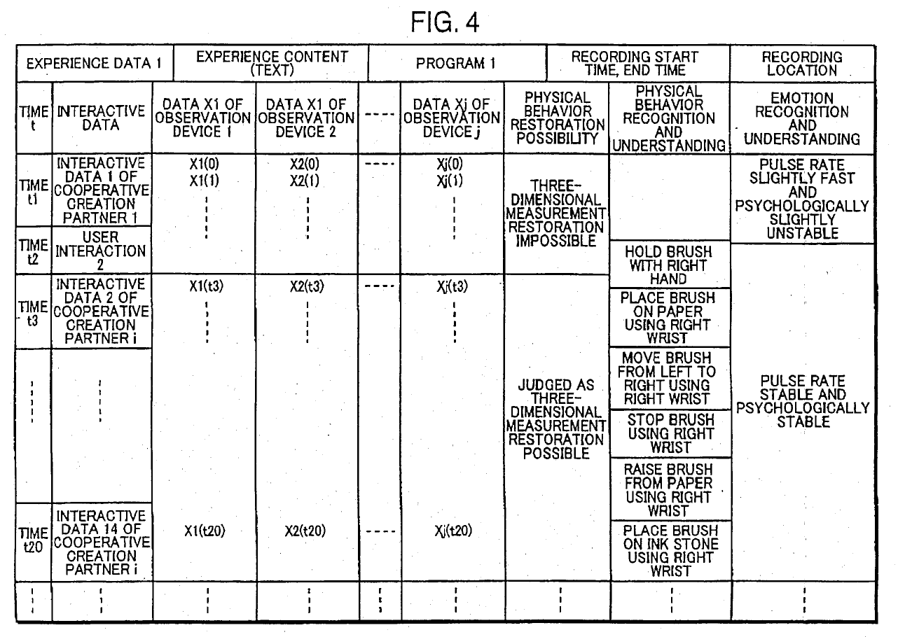

Now the case when the steps of brush work of calligraphy by a calligrapher is observed as experience information will be described. FIG. 4 is a diagram depicting an example of the data content of the sub-interaction corpus in the case when the steps of brush work of calligraphy by a calligrapher is observed as experience information.

In the example shown in FIG. 4, the cooperative creation partner i (i=11-1m) of the cooperative media 1a starts speaking to the user A at time t1, the observation devices 1-j (j is an arbitrary positive number) of the observation section 62 shows the status when the observation of the experience information has begun, and at time t2, user A responds. Also shown is that at time intervals t1-t2, three-dimensional calculation restoration Is Impossible.

Then at time t3, immediately after the cooperative creation partner i transmits the interaction data 2, three-dimensional measurement restoration becomes impossible, and observation enters an effective stage as the experience, information. Around time t3, physical behavior recognition and understanding processing begins outputting the result, and the time series of the brush work of the user can be restored in text format. In emotional recognition and understanding processing as well, it is known that the user A begins writing calligraphy in a psychologically stable status at around time t2, by measuring the pulse rate of the user. In this way, the measurement data from the measurement section, recognition and understanding result, recognition program, and physical information are stored in the sub-interaction corpus.

Now the operation of the cooperative media 1a and 1b, when the user A uses the cooperative media 1a and the user B uses the cooperative media 1b, will be described.

At first, the cooperative media 1a controls the five-sense media 21-2m according to the interaction with the user A, observes sound, images, biological information (including a smell of ink), and physical information, etc. on the experience of the user A, and creates the interaction corpus 52 on language information and non-language information by recognition and understanding processing, and also observes the experience by a plurality of cooperative creation partners 11-1m, and integrates individual observation results. The cooperative media 1a checks whether the experience information has a missing part, and performs measurement again if necessary.

Then the user B searches the experience information of the user A via the network 3 using the cooperative media 1b, so as to transfer the experience of the user A to the user B. When the media biological information, physical information environment and other to be observed are different between the user A and user B, an attribute data for identifying these differences is created in the interaction corpus, and mutual conversion is performed between the users. In other words, the cooperative media 1b of the user B compares the interaction corpus between the user A and the user B, and reproduces data to share an experience in the media environment of the user B.

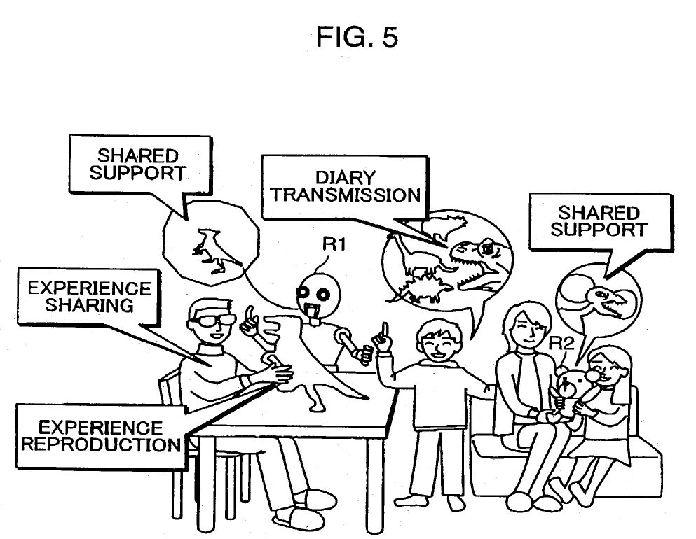

FIG. 5 is a diagram depicting an example of shared experience communication to share an experience and create a new experience. As FIG. 5 shows, during family time, the family receives the content of the class a boy experienced at school using the experience transfer system shown in FIG. 1, and a now experience is created for the entire family sharing the experience of the boy. At this time, in order to deepen understanding and increase new ideas and creativity, the humanoid type robot R1 or the stuffed toy type robot R2 is produces effects interactively so that the father of the boy can have the pseudo-experience of touching the skin of a dinosaur. These robots detect content while listening to the conversation of the family, automatically collects data close to the content, experience data at school in this case, and presents it to the family. In this way, the current bothersome Internet search can be avoided.

Now the operation of the education media 2a and 2b, when an expert uses the education media 2a and a learner uses the education media 2b, will be described.

At first, the education media 2a accurately measures the creation steps and the actions of the expert in the target creation activity. Then the education media 2a extracts the important factors to exhibit an excellent effect in the creation result from the creation steps. Here the important factors can be specified by pre-examining the correlation between the physical parameters in, various time spaces in many creation steps, and evaluation values for the corresponding parts of the creation result. In this way, each extracted factor of the creation steps is labeled for each step, and dictionary data on sensitivity and skills is stored in the interaction corpus in the education media 2a as skills information.

For the learner as well, similar creation steps and actions are measured, and each factor is extracted, and the personal dictionary data, where the sensitivity and skills of the learner is reflected, is stored in the interaction corpus in the education media 2b as personal information. This personal dictionary may be created by using a standard individual personal dictionary as the initial dictionary automatically updating the dictionary by the result of measuring follow up actions when steps of the model are shown, rather than creating a personal dictionary separately for each individual in advance. In this case, the latest personal dictionary is available along with the improvement of the skills of the learner due to this update processing.

The education media 2b compares the difference between each factor stored in the interaction corpus in the education media 2a to be the sensitivity and skills dictionary to be the model created by the expert and each factor stored in the interaction corpus in the education media 2b to be a personal dictionary of the learner, reduces the difference of each factor so as to be a level slightly higher than the level which the learner can maintain, adds the difference to each factor of the personal dictionary of the learner, and presents this as the model using five-sense media.

By the above processing, the learner can refer to the best model at each point of time, without being forced to copy the advanced skills of the export from the beginning, or ignoring individual traits of the expert.

This application is based on Japanese patent applications serial No. 2002-30809, filed in Japan Patent Office on Feb. 7, 2002. the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An interaction media device, comprising:
acquisition means for acquiring experience information on human experience;
storage means for storing the experience information acquired by said acquisition means;
reproduction means for reproducing the experience; and
control means for controlling the operation of said acquisition means, said storage means and said reproduction means, wherein said control means controls the operation of said acquisition means, said storage means, and said reproduction means so that said control means interacts with a human autonomously and cooperatively.

2. The interaction media device according to claim 1, wherein when an experience is reproduced, said reproduction means compares the experience information stored in said storage means and experience information of the experience to be reproduced, and the experience information on the experience to be reproduced is converted into reproducible information.

3. The interaction media device according to claim 1, wherein said acquisition means, said storage means, said reproduction means, and said control means constitute a cooperative creation partner device for interacting with humans autonomously and cooperatively;
said acquisition means, said storage means, said reproduction means, and said control means includes a plurality of acquisition means, a plurality of storage means, a plurality of reproduction means, and a plurality of control means, respectively,
said plurality of acquisition means, said plurality of storage means, said plurality of reproduction means, and said plurality of control means constitute a plurality of said cooperative creation partner means, and
cooperative control means for controlling the operation of said plurality of cooperative creation partner devices cooperatively is further comprised so as to produce a predetermined effect and to guide humans to a predetermined target.

4. The interaction media device according to claim 1, wherein said acquisition means includes a visual information observation section for observing a visual information of the user; an auditory information observation section for observing an auditory information of the user, and a tactical & biological information section for observing a tactical and biological information of the user.

5. The interaction media device according to claim 4, wherein said tactical and biological information section observes a temperature, a humidity, a wind force and an ion concentration of an environment surrounding the user.

6. The interaction media device according to claim 5, wherein said reproduction means includes an image display section for displaying images, a sound synthesis section for synthesizing sounds, and a physical sensation information reproduction section for reproducing the information corresponding to the physical sensation of the user.

7. The interaction media device according to claim 1, further comprising a recognition standard dictionary section which stores referenced size information about predetermined parts of a human body and performs normalization processing for a user who has a different size information regarding said predetermined parts from said referenced size information by adjusting the parameters based on the referenced size information.

8. The interaction media device according to claim 7, wherein said reproduction means including:
a media conversion section for comparing the size information on the predetermined parts of the human body of a first user and the information on the size information in the predetermined parts of a second user based on the referenced size information to create a conversion dictionary; and
a conversion dictionary section for storing said conversion dictionary.

9. The interaction media device according to claim 8, wherein said reproduction means further including:
a synthesizing program section for storing a set of parameters for converting said size information of a user based on the referenced size information so that said media conversion section performs a normalization processing over the acquired experienced information of the first user in terms of said size information of the predetermined parts of the first user who has experienced a first event from which said acquired experienced information was obtained.

10. An experience transfer system for mutually transferring human experience, comprising a first and second interaction media devices which are connected so as to communicate mutually via a predetermined network, wherein
said first interaction media device acquires and stores the experience information of a first user by interacting with the first user autonomously and cooperatively; and
said second interaction media device has a second user have the vicarious experience of the experience of the first user using the experience information of the first user, which is read from said first interaction media device via said network.

11. The experience transfer system according to claim 10, wherein said first user includes an expert, and said second user being a learner;
said first interaction media device acquires and stores the skills information of the expert by interacting with the expert autonomously and cooperatively; and
said second interaction media device acquires and stores the personal information of the learner by interacting with the learner autonomously and cooperatively, and has the learner have the vicarious experience of the experience of the expert using the skills information of the expert, read from said first interaction media device via said network and stored personal information of the learner, so that the experience transfer is adapted to the learner.

12. The experience transfer system according to claim 10, wherein each of said first and second interaction media devices include an interaction media device that comprises:
acquisition means for acquiring experience information on human experience;
storage means for storing the experience information acquired by said acquisition means;
reproduction means for reproducing the experience; and control means for controlling the operation of said acquisition means, said storage means and said reproduction means, wherein said control means controls the operation of said acquisition means, said storage means, and said reproduction means so that said control means interacts with a human autonomously and cooperatively.

13. The experience transfer system according to claim 11, wherein each of said first and second interaction media devices include an interaction media device that comprises:
acquisition means for acquiring experience information on human experience;
storage means for storing the experience information acquired by said acquisition means;
reproduction means for reproducing the experience; and control means for controlling the operation of said acquisition means, said storage means and said reproduction means, wherein said control means controls the operation of said acquisition means, said storage means, and said reproduction means so that said control means interacts with a human autonomously and cooperatively.
